(19) United States
(12) Patent Application Publication
(10) Pub. No.: US 2025/0336167 A1
(43) Pub. Date: Oct. 30, 2025

(54) METHOD, APPARATUS, DEVICE AND STORAGE MEDIUM FOR IMAGE PROCESSING

(71) Applicant: Beijing Zitiao Network Technology Co., Ltd., Beijing (CN)

(72) Inventor: Lihui TIAN, Beijing (CN)

(21) Appl. No.: 18/871,050

(22) PCT Filed: May 26, 2023
(86) PCT No.: PCT/CN2023/096612

§ 371 Date: Dec. 2, 2024

(30) Foreign Application Priority Data
Jun. 2, 2022 (CN) 202210626337.8

(51) Int. Cl. G06T 19/20; G06T 3/00; G06T 5/70; G06T 17/20

(52) U.S. Cl. CPC G06T 19/20; G06T 3/00; G06T 5/70; G06T 17/20; G06T 2207/30201; G06T 2210/12; G06T 2219/2016

(57) ABSTRACT

The disclosure provides a method, apparatus, device and storage medium for image processing. The method for image processing includes: performing three-dimensional reconstruction on an original face image to obtain an initial 3D model; transforming the initial 3D model according to predetermined transformation information to obtain a transformed 3D model; performing expansion processing on the transformed 3D model to obtain an expanded 3D model; determining a displacement image based on the expanded 3D model and the initial 3D model; and performing transformation processing on the original face image according to the displacement image to obtain a target face image.

This application claims priority to Chinese Patent Application No. 202210626337.8, filed with the Chinese Patent Office on Jun. 2, 2022 and entitled “METHOD, APPARATUS, DEVICE AND STORAGE MEDIUM FOR IMAGE PROCESSING”, the entirety of which is incorporated herein by reference.

### FIELD

The present disclosure relates to the field of image processing, for example, to a method, an apparatus, a device and storage medium for image processing.

### BACKGROUND

The portrait editing approach reconstructs a three-dimension (3D) model, adjusts the face orientation and angle on the 3D model, then renders to a 2D image. However, this approach is limited by the accuracy of the 3D model, resulting in the edited face image unnatural.

### SUMMARY

The present disclosure provides a method, an apparatus, a device and storage medium for image processing, which can realize transformation processing of a facial image to make the transformed fac facial image more natural and thus improve the display effect of the image.

In a first aspect, the present disclosure provides an image processing method, comprising:
performing three-dimensional reconstruction on an original face image to obtain an initial 3D model;
transforming the initial 3D model according to predetermined transformation information to obtain a transformed 3D model;
performing expansion processing on the transformed 3D model to obtain an expanded 3D model;
determining a displacement image based on the expanded 3D model and the initial 3D model; and
performing transformation processing on the original face image according to the displacement image to obtain a target face image.

In a second aspect, the present disclosure further provides an image processing apparatus, comprising:
an initial 3D model obtaining module configured for performing three-dimensional reconstruction on an original face image to obtain an initial 3D model;
a transformed 3D module obtaining module configured for transforming the initial 3D model according to predetermined transformation information to obtain a transformed 3D model;
an expanded 3D model obtaining module configured for performing expansion processing on the transformed 3D model to obtain an expanded 3D model;
a displacement image determining module configured for determining a displacement image based on the expanded 3D model and the initial 3D model; and
a target face image obtaining module configured for performing transformation processing on the original face image according to the displacement image to obtain a target face image.

In a third aspect, the present disclosure further provides an electronic device, comprising: one or more processors;
a storage device configured for storing one or more programs,
the one or more programs, when executed by the one or more processors, causing the one or more processors to implement the image processing method described above.

In a fourth aspect, the present disclosure further provides a storage medium containing computer
executable instructions which, when executed by a computer processor, are for performing the image processing method described above.

In a fifth aspect, the present disclosure further provides a computer program product, comprising a computer program carried on a non-transient computer readable medium, the computer program containing program code for performing the image processing method described above.

### BRIEF DESCRIPTION OF THE DRAWINGS

FIG. 1 is a schematic flowchart of an image processing method according to an embodiment of the present disclosure;

FIG. 2a is a schematic diagram of determining a bounding rectangular box of a transformed 3D model according to an embodiment of the present disclosure;

FIG. 2b is a schematic diagram of determining another bounding rectangular box of a transformed 3D model according to an embodiment of the present disclosure;

FIG. 3 is an example diagram of determining an expanded vertex according to an embodiment of the present disclosure;

FIG. 4 is an example diagram of a constructed expanded mesh according to an embodiment of the present disclosure;

FIG. 5 is a schematic structural diagram of an image processing apparatus according to an embodiment of the present disclosure; and

FIG. 6 is a schematic structural diagram of an electronic device according to an embodiment of the present disclosure.

### DETAILED DESCRIPTION

The embodiments of the present disclosure will be described in more detail with reference to the accompanying drawings, in which some embodiments of the present disclosure have been illustrated. However, the present disclosure can be implemented in various manners, and those embodiments are provided for a better understanding of the present disclosure. The drawings and embodiments of the present disclosure are only used for illustration.

Various steps described in method implementations of the present disclosure may be performed in a different order and/or in parallel. In addition, the method implementations may comprise an additional step and/or omit a step which is shown. The scope of the present disclosure is not limited in this regard.

The term “comprise” and its variants used here are to be read as open terms that mean “include, but is not limited to.” The term “based on” is to be read as “based at least in part on.” The term “one embodiment” is to be read as “at least one embodiment.” The term “another embodiment” is to be read as “at least one other embodiment.” The term “some embodiments” is to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more”.

Names of messages or information interacted between a plurality of apparatuses in the implementations of the present disclosure are merely for the illustration purpose, rather than limiting the scope of these messages or information.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative and does not limit the implementations of the present disclosure. Other methods that satisfy relevant laws and regulations are also applicable to the implementations of the present disclosure.

It is to be understood that the data involved in this technical solution (including but not limited to the data itself, data acquisition or use) should comply with the requirements of corresponding laws and regulations and relevant provisions.

Most of the facial image editing methods are implemented based on 2D image deformation. These methods generally obtain 2D facial key points through a detection algorithm, change positions of the facial key points according to a predetermined rule or a user-defined rule, and deform an image according to positions of the facial key points before and after the change, so as to accomplish a facial deformation function. However, due to lack of depth information of the face, the face orientation and angle cannot be adjusted while maintaining facial features.

In another facial image editing method, by reconstructing a 3D model, the face orientation and angle are adjusted on the 3D model before being rendered into the 2D image. However, this method is limited by the precision of the 3D model and the accuracy of the reconstruction algorithm, the face boundary resulting from the rendering is sharp, the intersection of model facets leads to an angularity problem, so that an unnatural rendering result is unnatural.

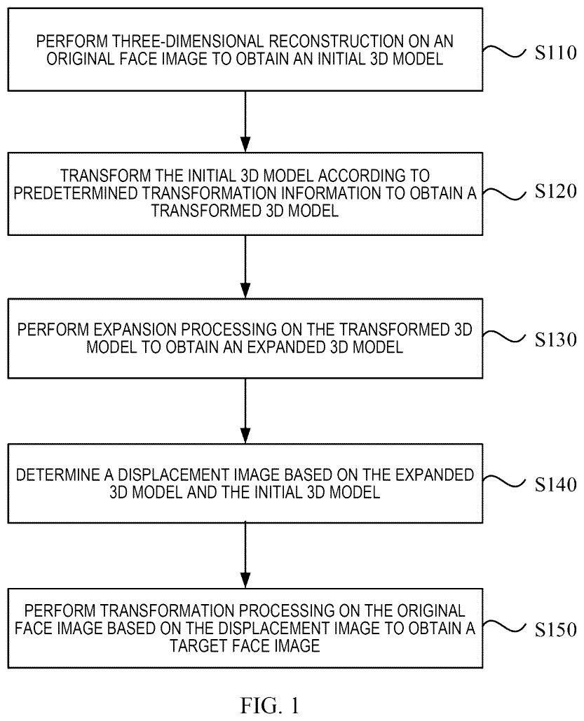

FIG. 1 is a schematic flowchart of an image processing method provided by an embodiment of the present disclosure. The embodiment of the present disclosure is applicable to a case in which a face image is transformed. The method may be performed by an image processing apparatus. The apparatus may be implemented in a form of software and/or hardware, for example, implemented by an electronic device, which may be a mobile terminal, a personal computer (PC) terminal, a server, or the like.

As shown in FIG. 1, the method includes:

S110, performing three-dimensional reconstruction on an original face image to obtain an initial 3D model.

The original face image may be a to-be-processed image containing a face, which may be a face image collected in real time, or authorized for use from a network database, or obtained from a local database. The 3D model may be a 3D mesh model, the mesh consisting of vertices and lines. The 3D model includes three-dimensional coordinate information and normal information of the facial 3D vertices.

In this embodiment, any three-dimensional reconstruction algorithm may be used for the three-dimensional reconstruction of the original face image, which is not limited herein. For example, the original face image may be input into a trained three-dimensional reconstruction neural network model, and the initial 3D model is output.

S120, transforming the initial 3D model according to predetermined transformation information to obtain a transformed 3D model.

The predetermined transformation information may include transformation information of a face angle and/or an orientation. The predetermined transformation information may be determined according to a predetermined transformation parameter or according to adjustment information triggered by a user for the face image.

In this embodiment, a manner of transforming the initial 3D model according to the predetermined transformation information to obtain the transformed 3D model may be: generating a transformation matrix according to the predetermined transformation information; and transforming the initial 3D model based on the transformation matrix to obtain the transformed 3D model.

A transformation vector corresponding to the predetermined transformation information is determined, and the transformation matrix is formed from the transformation vector. A process of transforming the initial 3D model based on the transformation matrix may be: performing point multiplication on the transformation matrix and a matrix formed by vertex data of the initial 3D model, to obtain the transformed 3D model. In this embodiment, the initial 3D model is transformed based on the transformation matrix, which can improve the efficiency and accuracy of transforming the 3D model.

S130, performing expansion processing on the transformed 3D model to obtain an expanded 3D model.

Performing the expansion processing on the transformed 3D model may be understood as expanding the transformed 3D model outwards. The process may be: first adding a new vertex on the periphery of the transformed 3D model, then constructing a new mesh with the new vertex and a set vertex on the transformed 3D model, and forming the new mesh and the transformed 3D mode into the expanded 3D model.

In this embodiment, a manner of performing the expansion processing on the transformed 3D model to obtain the expanded 3D model may be: selecting a plurality of target vertices from the transformed 3D model; determining a plurality of expanded vertices respectively corresponding to the plurality of target vertices to obtain a plurality of expanded vertices; constructing a triangular mesh based on the plurality of target vertices and the plurality of expanded vertices to obtain an expanded mesh; and forming the expanded 3D model with the expanded mesh and the transformed 3D model.

The target vertex may be a facial edge vertex of the transformed 3D model. The edge vertex may be understood as a vertex of the transformed 3D model corresponding to the facial edge point of the two-dimensional image after the transformed 3D model is projected onto a two-dimensional plane. In this embodiment, there are a plurality of facial edge vertices, and the target vertex may be all the facial edge vertices, or the facial edge vertex sampled from all the facial edge vertices.

A manner of determining the plurality of expanded vertices respectively corresponding to the plurality of target vertices may be: adding a corresponding expanded vertex according to position coordinates of the target vertex. In this embodiment, a manner of determining the plurality of expanded vertices respectively corresponding to the plurality of target vertices may be: obtaining a bounding rectangular box of the transformed 3D model; and determining the expanded vertex on an extension line of a line connecting a center point of the bounding rectangular box and the target vertex based on size information of the bounding rectangular box.

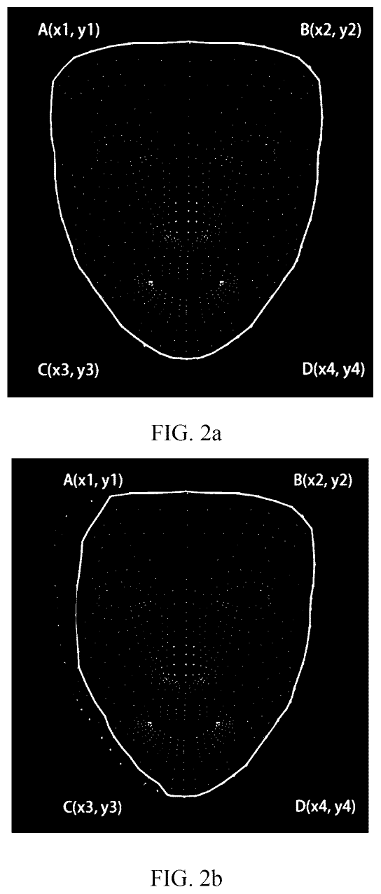

The size information of the surrounding rectangular box includes width and/or height. The bounding rectangular box may be a circumscribed rectangular box of the two-dimensional face image after the transformed 3D model is projected onto the two-dimensional plane. For example, FIG. 2a and FIG. 2b are bounding rectangular boxes of the determined transformed 3D model, among which FIG. 2a is a front face image and FIG. 2b is a side face image. As shown in FIG. 2a and FIG. 2b, a bounding rectangular box ABCD is an circumscribed rectangular box of a face image, and may also be understood as a range box of a face vertex on an x-axis and a y-axis, where x1=x3 is the minimum value of the face vertex on the x-axis, x2=x4 is the maximum value of the face vertex on the x-axis, y1=y2 is the maximum value of the face vertex on the y-axis, and y3=y4 is the minimum value of the face vertex on the y-axis. The width of the x2-x1 bounding rectangular box is denoted as w, the height of the y1-y3 bounding rectangular box is denoted as h, and the center point of the face (i.e., the center point of the bounding box) O is the intersection of the connection line AD or BC.

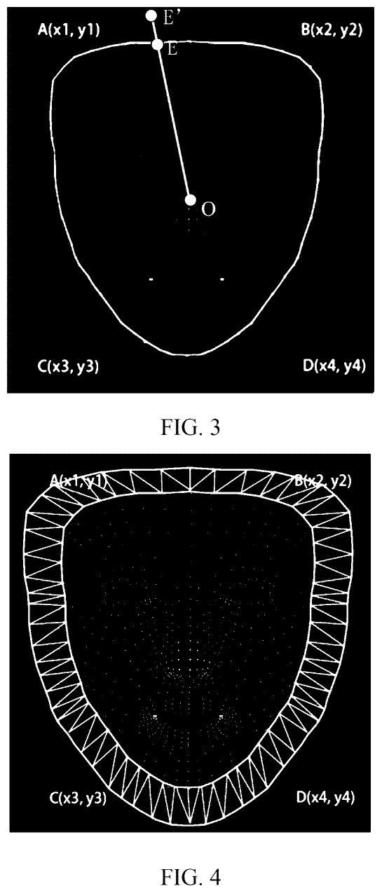

The process of determining the expanded vertex on the extension line of the line connecting the center point of the bounding rectangular box and the target vertex based on the size information of the bounding rectangular box may be understood as: adding an expanded vertex on the extension line of the line connecting the center point of the bounding rectangular box and the target vertex, so that the distance between the target vertex and the expanded vertex is w/n, or h/n, or max (w/n, h/n), where N is an adjustable parameter and may be any value greater than 0, for example, n is 5. As an example, FIG. 3 is an example diagram of determining an expanded vertex in this embodiment. As shown in FIG. 3, O is a center point of a bounding box, E is one of target vertices, and an expanded vertex E ‘is newly added to an extension line of a connection line OE, where EE’ has a length of w/n, h/n, or max (w/n, h/n). In this embodiment, the expanded vertex is determined on the extension line of the line connecting the center point of the bounding rectangular box and the target vertex based on the size information of the bounding rectangular box, so that the expansion size of the model can be constrained.

In this embodiment, after the plurality of expanded vertices are obtained, the triangular mesh is constructed according to the plurality of target vertices and the plurality of expanded vertices. As an example, FIG. 4 is an example diagram of an expanded mesh constructed in this embodiment. As shown in FIG. 4, a plurality of target vertices and a plurality of expanded vertices are connected into lines according to a certain rule, and every three lines form a triangular mesh. Finally, the expanded mesh and the transformed 3D mesh model constitute an expanded 3D mesh model, that is, an expanded 3D model. In this embodiment, the problem of unnatural face and background transition can be solved by performing the expansion processing on the transformed 3D model.

S140, determining a displacement image based on the expanded 3D model and the initial 3D model.

The displacement image is used to characterize displacement information between vertices of the expanded 3D model and the initial 3D model.

The process of determining the displacement image based on the expanded 3D model and the initial 3D model may be: determining displacement information of a plurality of vertices based on the expanded 3D model and the initial 3D model; and generating the displacement image based on the displacement information.

In this embodiment, the position coordinates of the 3D vertex of the expanded 3D model are subtracted from the position coordinates of the corresponding 3D vertex in the initial 3D model to obtain displacement information of the 3D vertex, which is represented as T (Tx, Ty, Tz). A manner of generating the displacement image based on the displacement information may be: obtaining the displacement image by taking and rendering (Tx, Ty) values into the image. The displacement image may be a four-channel image, which may be a red-green-blue-alpha (Red-Green-Blue-Alpha, RGBA) four-channel image. A manner of taking and rendering the (Tx, Ty) values into the four-channel image may be: rounding the Tx value by 255 for the R channel value, rounding the Tx value by 255 and multiplying the remainder by 255 as the G channel value, rounding the Ty value by 255 for the B channel value, rounding the Ty value by 255 and multiplying the remainder by 255 as the A channel value. Alternatively, the Tx value is used as the R channel value, the Ty value is used as the G channel value, and values of the B channel and the A channel are set to 0.

In this embodiment, since the expanded 3D model has more expanded meshes than the initial 3D model, the displacement information of the expanded vertices may be determined as (0, 0). In this embodiment, generating the displacement image based on the displacement information of the 3D vertex can improve the accuracy of generating the displacement image.

S150, transforming the original face image according to the displacement image to obtain a target face image.

A plurality of pixels in the original face image are in one-to-one correspondence with a plurality of pixels in the displacement image, and a pixel value of each pixel in the displacement image characterizes displacement information of a corresponding pixel in the original face image. In this embodiment, the process of transforming the original face image according to the displacement image to obtain the target face image may include: obtaining initial coordinates of a pixel in the original face image and displacement information of the pixel in the displacement image; determining transformed coordinates based on the initial coordinates and the displacement information; and rendering a pixel value of the pixel to a position corresponding to the transformed coordinates to obtain the target face image.

A manner of determining the transformed coordinates based on the initial coordinates and the displacement information may be: accumulating the initial coordinates and the displacement information to obtain the transformed coordinates. For example, assuming that the initial coordinates are (x, y) and the displacement information is (Tx, Ty), the transformed coordinates are (x+Tx, y+Ty). The process of rendering the pixel value of the pixel to the position corresponding to the transformation coordinates may be: first creating an empty texture having the same size as the original face image, and then rendering the pixel value of the pixel in the original face image to the position corresponding to the transformation coordinates in the empty texture to obtain the target face image. Alternatively, the initial coordinates corresponding to the pixel in the empty texture in the original face image are determined according to the position coordinates of the pixel in the empty texture and the displacement information in the displacement image, and then the pixel value of the pixel in the initial coordinates is rendered to the position of the pixel in the empty texture. In this embodiment, the pixel value of the pixel is rendered to the position corresponding to the transformation coordinates, so that the original face image can be accurately transformed.

In this embodiment, since the 3D model has a boundary and the intersection of the model facets is relatively sharp, adjacent pixel displacement information corresponding to the intersection of the model facets in the obtained displacement image hops, and the displacement image needs to be blurred.

A manner of transforming the original face image according to the displacement image to obtain the target face image may be: performing the blurring processing on the displacement image; and transforming the original face image based on the blurred displacement image to obtain the target face image.

A manner of performing the blurring processing on the displacement image may be: invoking any blur processing algorithm to process the displacement image. The manner of performing the blurring processing on the displacement image may be: determining a blur radius; and performing the blurring processing on the displacement image based on the blur radius.

The blur radius may be determined based on the size of the bounding rectangular box of the face image or set by the user. For example, the blur radius may be set as a set value, or w/m, or h/m, or max (w/m, h/m), where m is an adjustable parameter and may be any value greater than 0. In this embodiment, the manner of performing the blurring processing on the displacement image may be: blurring a full image, or blurring different areas with different blur radii.

In this embodiment, a manner of determining the blur radius may be: dividing the displacement image into a facial area and a background area; determining a blur radius of the facial area as a first blur radius; and determining a blur radius of the background region as a second blur radius.

The second blur radius is greater than the first blur radius. The first blur radius may be a set value, or w/m, or h/m, or max (w/m, h/m), or the like. In this embodiment, a manner of dividing the displacement image into the facial area and the background area may be: determining an area formed by pixels whose distance from the center point of the face is less than a set value as the facial area, and determining an area formed by pixels whose distance from the center point of the face is greater than or equal to the set value as the background area.

The second blur radius varies with the distance between the pixel in the background area and the center point of the face, that is, the second blur radius increases with the increase of the distance between the pixel and the center point of the face. As an example, assuming that the blur radius of the facial area is set to A, the blur radius of the background area increases gradually from A as the distance between the pixel and the center point of the face increases. In this embodiment, the facial area and the background area are blurred with different blur radii, so that the angularity problem caused by the intersection of facets in the facial area can be resolved to the greatest extent.

In this embodiment, after the displacement image is blurred, the original face image is transformed based on the blurred displacement image to obtain the target face image, so that the obtained target face image avoids the angularity problem and a sharp boundary problem.

According to the technical solution of the embodiments of the present disclosure, three-dimensional reconstruction is performed on an original face image to obtain an initial 3D model; the initial 3D model is transformed according to predetermined transformation information to obtain a transformed 3D model; expansion processing is performed on the transformed 3D model to obtain an expanded 3D model; a displacement image is determined according to the expanded 3D model and the initial 3D model; and transformation processing is performed on the original face image according to the displacement image to obtain a target face image. According to the image processing method provided by the embodiment of the present disclosure, the problem of unnatural transition between the face and the background can be solved by performing expansion processing on the transformed 3D model, and the sharp boundary problem of the model and the angularity problem caused by the intersection of model facets can be solved by performing transformation processing on the original face image through the displacement image, so that the transformed face image is more real and natural and the display effect of the image is improved.

FIG. 5 is a schematic structural diagram of an image processing apparatus according to an embodiment of the present disclosure. As shown in FIG. 5, the apparatus comprises:
an initial 3D model obtaining module 410 configured for performing three-dimensional reconstruction on an original face image to obtain an initial 3D model; a transformed 3D module obtaining module 420 configured for transforming the initial 3D model according to predetermined transformation information to obtain a transformed 3D model; an expanded 3D model obtaining module 430 configured for performing expansion processing on the transformed 3D model to obtain an expanded 3D model; a displacement image determining module 440 configured for determining a displacement image based on the expanded 3D model and the initial 3D model; and a target face image obtaining module 450 configured for performing transformation processing on the original face image according to the displacement image to obtain a target face image.

In an embodiment, the transformed 3D module obtaining module 420 is further configured for:
generating a transformation matrix according to the predetermined transformation information; and transforming the initial 3D model based on the transformation matrix to obtain the transformed 3D model.

In an embodiment, the expanded 3D model obtaining module 430 is further configured for:
selecting a plurality of target vertices from the transformed 3D model; determining a plurality of expanded vertices respectively corresponding to the plurality of target vertices to obtain a plurality of expanded vertices; constructing a triangular mesh based on the plurality of target vertices and the plurality of expanded vertices to obtain an expanded mesh; and forming the expanded 3D model with the expanded mesh and the transformed 3D model.

In an embodiment, the expanded 3D model obtaining module 430 is further configured for:
obtaining a bounding rectangular box of the transformed 3D model; determining an expanded vertex on an extension line of a line connecting a center point of the bounding rectangular box and the target vertex based on size information of the bounding rectangular box; wherein the size information of the bounding rectangular box includes width and/or height.

In an embodiment, the displacement image determining module 440 is further configured for:
determining displacement information of a plurality of vertices based on the expanded 3D model and the initial 3D model; and generating the displacement image based on the displacement information.

In an embodiment, the target face image obtaining module 450 is further configured for:
performing blurring processing on the displacement image; and performing transformation
processing on the original face image based on the blurred displacement image to obtain the target face image.

In an embodiment, the target face image obtaining module 450 is further configured for:
determining a blur radius; and performing the blurring processing on the displacement image based on the blur radius.

In an embodiment, the target face image obtaining module 450 is further configured for:
dividing the displacement image into a facial area and a background area; determining a blur radius of the facial area as a first blur radius; and determining a blur radius of the background area as a second blur radius; wherein the second blur radius is greater than the first blur radius.

In an embodiment, the second blur radius varies with a distance between a pixel in the background area and the center point of the face.

In an embodiment, the target face image obtaining module 450 is further configured for:
obtaining initial coordinates of a pixel in the original face image and displacement information of the pixel in the displacement image; determining transformation coordinates based on the initial coordinates and the displacement information; and rendering a pixel value of the pixel to a position corresponding to the transformation coordinates to obtain the target face image.

The image processing apparatus provided by the embodiment of the present disclosure may perform the image processing method provided by any embodiment of the present disclosure, and has corresponding functional modules and effects for performing the method.

The plurality of units and modules included in the above apparatus are divided only according to functional logic, but are not limited to the above division, as long as corresponding functions can be implemented; in addition, the names of the plurality of functional units are also only for the convenience of differentiation between each other, and are not intended to limit the protection scope of the embodiments of the present disclosure.

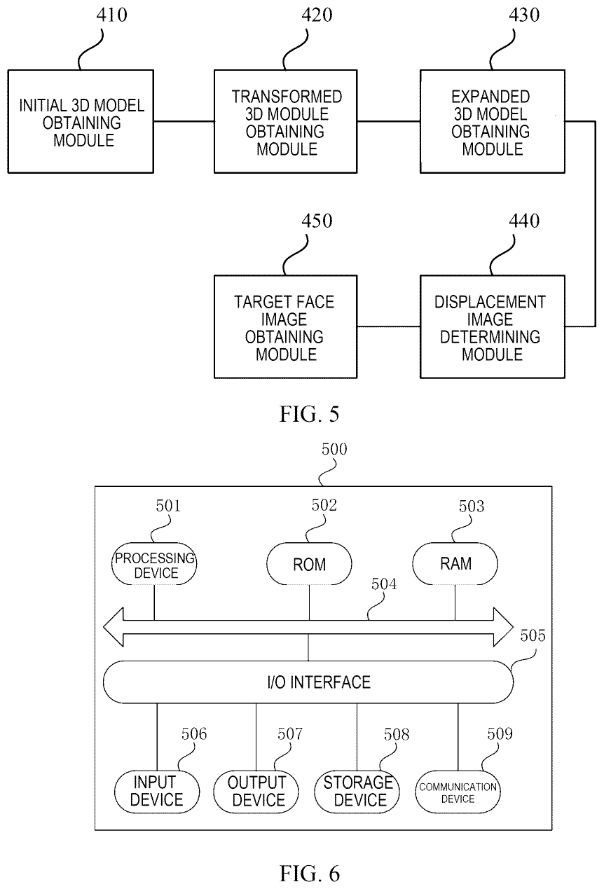

FIG. 6 is a structural schematic diagram of an electronic device provided by an embodiment of the present disclosure. With reference to FIG. 6, this figure shows a structural schematic diagram of an electronic device (e.g., a terminal device or server in FIG. 6) 500 which is applicable to implement the embodiments of the present disclosure. The terminal device in the embodiments of the present disclosure may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer, a smart home device and the like. The electronic device shown in FIG. 6 is merely an example and should not be construed as bringing any restriction on the functionality and usage scope of the embodiments of the present disclosure.

As shown in FIG. 6, the electronic device 500 may comprise a processing device (e.g., a central processor, a graphics processor) 501 which is capable of performing various appropriate actions and processes to realize the method of table processing as described in the embodiments of the present disclosure in accordance with programs stored in a read only memory (ROM) 502 or programs loaded from a storage device 508 to a random access memory (RAM) 503. In the RAM 503, there are also stored various programs and data required by the electronic device 500 when operating. The processing device 501, the ROM 502 and the RAM 503 are connected to one another via a bus 504. An input/output (I/O) interface 505 is also connected to the bus 504.

Usually, the following devices may be connected to the I/O interface 505: an input device 506 including a touch screen, a touch pad, a keyboard, a mouse, a camera, a microphone, an accelerometer, a gyroscope, or the like; an output device 507, such as a liquid-crystal display (LCD), a loudspeaker, a vibrator, or the like; a storage device 508, such as a magnetic tape, a hard disk or the like; and a communication device 509. The communication device 509 allows the electronic device to perform wireless or wired communication with other device so as to exchange data with other device. While FIG. 6 shows the electronic device 500 with various devices, it should be understood that it is not required to implement or have all of the illustrated devices. Alternatively, more or less devices may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication device 509, or installed from the storage device 508, or installed from the ROM 502. The computer program, when executed by the processing device 501, perform the above functions defined in the method of the embodiments of the present disclosure.

The names of messages or information interacted between a plurality of apparatuses in the implementations of the present disclosure are merely for the purpose of illustration, rather than limiting the scope of these messages or information.

The electronic device provided by the embodiment of the present disclosure belongs to the same inventive concept as the image processing method provided by the above embodiments of the present disclosure. For technical details that are not described in this embodiment, reference may be made to the above embodiments. Moreover, this embodiment has the same advantageous effects as the above embodiments.

An embodiment of the present disclosure provides a computer storage medium, storing a computer program thereon which, when executed by a processor, implements a method for rendering a 3D virtual object provided by the above embodiments.

The computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, the client and the server may communicate using any network protocol that is currently known or will be developed in future, such as the hyper text transfer protocol (HTTP) and the like, and may be interconnected with digital data communication (e.g., communication network) in any form or medium. Examples of communication networks include local area networks (LANs), wide area networks (WANs), inter-networks (e.g., the Internet) and end-to-end networks (e.g., ad hoc end-to-end networks), as well as any networks that are currently known or will be developed in future.

The above computer readable medium may be included in the above-mentioned electronic device; and it may also exist alone without being assembled into the electronic device.

The computer readable medium carries one or more programs which, when executed by the electronic device, cause the electronic device to:

The computer readable medium carries one or more programs which, when executed by the electronic device, cause the electronic device to: perform three-dimensional reconstruction on an original face image to obtain an initial 3D model; transform the initial 3D model according to predetermined transformation information to obtain a transformed 3D model; perform expansion processing on the transformed 3D model to obtain an expanded 3D model; determine a displacement image based on the expanded 3D model and the initial 3D model; and perform transformation processing on the original face image according to the displacement image to obtain a target face image.

Computer program codes for carrying out operations of the present disclosure may be written in one or more programming languages, including without limitation to, an object oriented programming language such as Java, Smalltalk, C++or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case. For example, the first obtaining unit may further be described as a “unit for obtaining at least two Internet protocol addresses”.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, an image processing method is provided, comprising:
performing three-dimensional reconstruction on an original face image to obtain an initial 3D model;
transforming the initial 3D model according to predetermined transformation information to obtain a transformed 3D model;
performing expansion processing on the transformed 3D model to obtain an expanded 3D model;
determining a displacement image based on the expanded 3D model and the initial 3D model; and
performing transformation processing on the original face image according to the displacement image to obtain a target face image.

According to one or more embodiments of the present disclosure, transforming the initial 3D model according to the predetermined transformation information to obtain the transformed 3D model comprises:
generating a transformation matrix according to the predetermined transformation information; and
transforming the initial 3D model based on the transformation matrix to obtain the transformed 3D model.

According to one or more embodiments of the present disclosure, performing expansion processing on the transformed 3D model to obtain the expanded 3D model comprises:
selecting a plurality of target vertices from the transformed 3D model;
determining a plurality of expanded vertices respectively corresponding to the plurality of target vertices to obtain a plurality of expanded vertices;
constructing a triangular mesh based on the plurality of target vertices and the plurality of expanded vertices to obtain an expanded mesh; and
forming the expanded 3D model with the expanded mesh and the transformed 3D model.

According to one or more embodiments of the present disclosure, determining the plurality of expanded vertices respectively corresponding to the plurality of target vertices comprises:
obtaining a bounding rectangular box of the transformed 3D model; and
determining an expanded vertex on an extension line of a line connecting a center point of the bounding rectangular box and the target vertex based on size information of the bounding rectangular box; wherein the size information of the bounding rectangular box includes width and/or height.

According to one or more embodiments of the present disclosure, determining the displacement image based on the expanded 3D model and the initial 3D model comprises:
determining displacement information of a plurality of vertices based on the expanded 3D model and the initial 3D model; and
generating the displacement image based on the displacement information.

According to one or more embodiments of the present disclosure, performing transformation processing on the initial face image based on the displacement image to obtain the target face image comprises:
performing blurring processing on the displacement image; and
performing transformation processing on the original face image based on the blurred displacement image to obtain the target face image.

According to one or more embodiments of the present disclosure, performing blurring processing on the displacement image comprises:
determining a blur radius; and
performing the blurring processing on the displacement image based on the blur radius.

According to one or more embodiments of the present disclosure, determining the blur radius comprises:
dividing the displacement image into a facial area and a background area;
determining a blur radius of the facial area as a first blur radius; and
determining a blur radius of the background area as a second blur radius; wherein the second blur radius is greater than the first blur radius.

According to one or more embodiments of the present disclosure, the second blur radius varies with a distance between a pixel in the background area and the center point of the face.

According to one or more embodiments of the present disclosure, performing transformation processing on the original face image according to the displacement image to obtain the target face image comprises:
obtaining initial coordinates of a pixel in the original face image and displacement information of the pixel in the displacement image;
determining transformation coordinates based on the initial coordinates and the displacement information; and
rendering a pixel value of the pixel to a position corresponding to the transformation coordinates to obtain the target face image.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

1-14. (canceled)

15. A method for image processing, comprising:
performing three-dimensional reconstruction on an original face image to obtain an initial 3D model;
transforming the initial 3D model according to predetermined transformation information to obtain a transformed 3D model;
performing expansion processing on the transformed 3D model to obtain an expanded 3D model;
determining a displacement image based on the expanded 3D model and the initial 3D model; and
performing transformation processing on the original face image according to the displacement image to obtain a target face image.

16. The method of claim 15, wherein transforming the initial 3D model according to the predetermined transformation information to obtain the transformed 3D model comprises:
generating a transformation matrix according to the predetermined transformation information; and
transforming the initial 3D model based on the transformation matrix to obtain the transformed 3D model.

17. The method of claim 15, wherein performing expansion processing on the transformed 3D model to obtain the expanded 3D model comprises:
selecting a plurality of target vertices from the transformed 3D model;
determining a plurality of expanded vertices respectively corresponding to the plurality of target vertices to obtain a plurality of expanded vertices;
constructing a triangular mesh based on the plurality of target vertices and the plurality of expanded vertices to obtain an expanded mesh; and
forming the expanded 3D model with the expanded mesh and the transformed 3D model.

18. The method of claim 17, wherein determining the plurality of expanded vertices respectively corresponding to the plurality of target vertices comprises:
obtaining a bounding rectangular box of the transformed 3D model; and
determining an expanded vertex on an extension line of a line connecting a center point of the bounding rectangular box and the target vertex based on size information of the bounding rectangular box; wherein the size information of the bounding rectangular box comprises at least one of a width and a height.

19. The method of claim 15, wherein determining the displacement image based on the expanded 3D model and the initial 3D model comprises:
determining displacement information of a plurality of vertices based on the expanded 3D model and the initial 3D model; and
generating the displacement image based on the displacement information.

20. The method of claim 15, wherein performing transformation processing on the initial face image based on the displacement image to obtain the target face image comprises:
performing blurring processing on the displacement image; and
performing the transformation processing on the original face image based on the blurred displacement image to obtain the target face image.

21. The method of claim 20, wherein performing the blurring processing on the displacement image comprises:
determining a blur radius; and
performing the blurring processing on the displacement image based on the blur radius.

22. The method of claim 21, wherein determining the blur radius comprises:
dividing the displacement image into a facial area and a background area;
determining a blur radius of the facial area as a first blur radius; and
determining a blur radius of the background area as a second blur radius; wherein the second blur radius is greater than the first blur radius.

23. The method of claim 22, wherein the second blur radius varies with a distance between a pixel in the background area and a center point of a face.

24. The method of claim 15, wherein performing the transformation processing on the original face image based on the displacement image to obtain the target face image comprises:
obtaining initial coordinates of a pixel in the original face image and displacement information of the pixel in the displacement image;
determining transformation coordinates based on the initial coordinates and the displacement information; and
rendering a pixel value of the pixel to a position corresponding to the transformation coordinates to obtain the target face image.

25. An electronic device, comprising:
at least one processor;
a storage device configured for storing at least one program,
the at least one program, when executed by the at least one processor, causing the at least one processor to implement acts comprising:
performing three-dimensional reconstruction on an original face image to obtain an initial 3D model;
transforming the initial 3D model according to predetermined transformation information to obtain a transformed 3D model;
performing expansion processing on the transformed 3D model to obtain an expanded 3D model;
determining a displacement image based on the expanded 3D model and the initial 3D model; and
performing transformation processing on the original face image according to the displacement image to obtain a target face image.

26. The electronic device of claim 25, wherein transforming the initial 3D model according to the predetermined transformation information to obtain the transformed 3D model comprises:
generating a transformation matrix according to the predetermined transformation information; and
transforming the initial 3D model based on the transformation matrix to obtain the transformed 3D model.

27. The electronic device of claim 25, wherein performing expansion processing on the transformed 3D model to obtain the expanded 3D model comprises:
selecting a plurality of target vertices from the transformed 3D model;
determining a plurality of expanded vertices respectively corresponding to the plurality of target vertices to obtain a plurality of expanded vertices;
constructing a triangular mesh based on the plurality of target vertices and the plurality of expanded vertices to obtain an expanded mesh; and
forming the expanded 3D model with the expanded mesh and the transformed 3D model.

28. The electronic device of claim 27, wherein determining the plurality of expanded vertices respectively corresponding to the plurality of target vertices comprises:
obtaining a bounding rectangular box of the transformed 3D model; and
determining an expanded vertex on an extension line of a line connecting a center point of the bounding rectangular box and the target vertex based on size information of the bounding rectangular box; wherein the size information of the bounding rectangular box comprises at least one of a width and a height.

29. The electronic device of claim 25, wherein determining the displacement image based on the expanded 3D model and the initial 3D model comprises:
determining displacement information of a plurality of vertices based on the expanded 3D model and the initial 3D model; and
generating the displacement image based on the displacement information.

30. The electronic device of claim 25, wherein performing transformation processing on the initial face image based on the displacement image to obtain the target face image comprises:
performing blurring processing on the displacement image; and
performing the transformation processing on the original face image based on the blurred displacement image to obtain the target face image.

31. The electronic device of claim 30, wherein performing the blurring processing on the displacement image comprises:
determining a blur radius; and
performing the blurring processing on the displacement image based on the blur radius.

32. The electronic device of claim 31, wherein determining the blur radius comprises:
dividing the displacement image into a facial area and a background area;
determining a blur radius of the facial area as a first blur radius; and
determining a blur radius of the background area as a second blur radius; wherein the second blur radius is greater than the first blur radius.

33. The electronic device of claim 32, wherein the second blur radius varies with a distance between a pixel in the background area and a center point of a face.

34. A non-transitory storage medium containing computer executable instructions which, when executed by a computer processor, are configured for performing acts comprising:
performing three-dimensional reconstruction on an original face image to obtain an initial 3D model;
transforming the initial 3D model according to predetermined transformation information to obtain a transformed 3D model;
performing expansion processing on the transformed 3D model to obtain an expanded 3D model;
determining a displacement image based on the expanded 3D model and the initial 3D model; and
performing transformation processing on the original face image according to the displacement image to obtain a target face image.
